(19) United States
(12) Patent Application Publication
(10) Pub. No.: US 2024/0386231 A1
(43) Pub. Date: Nov. 21, 2024

(54) IMAGE FORMING APPARATUS

(71) Applicant: SHARP KABUSHIKI KAISHA, Sakai City (JP)

(72) Inventor: KAZUTAKA MATSUMOTO, Sakai City (JP)

(21) Appl. No.: 18/667,679

(22) Filed: May 17, 2024

(30) Foreign Application Priority Data
May 18, 2023 (JP) 2023-082057
Jun. 26, 2023 (JP) 2023-104138

(51) Int. Cl. G06K 15/02; B41J 2/447; G03G 15/01; G03G 15/04; G03G 15/043; G06K 15/14

(52) U.S. Cl. CPC G06K 15/1878; B41J 2/447; G03G 15/0115; G03G 15/04027; G03G 15/043; G06K 15/14

(57) ABSTRACT

An electrophotographic image forming apparatus that scans a surface of an image carrier with multiple beams emitted from a plurality of light emitting elements on a basis of image data of multiple colors including black comprises a bow corrector that performs electronic bow correction of image data of a predetermined color other than black in accordance with a bow characteristic of black; and a density smoothing processor that smoothens a density level difference of an image of the predetermined color subjected to the bow correction by a density smoothing process.

### CROSS-REFERENCE TO RELATED APPLICATION

The present application claims priority from Japanese Application JP2023-082057 and JP2023-104138, the content to which is hereby incorporated by reference into this application.

### BACKGROUND OF THE INVENTION

### 1. Field of the Invention

The disclosure relates to an image forming apparatus and the like.

### 2. Description of the Related Art

An electrophotographic image forming apparatus is known in which a light beam emitted from a light source, such as a semiconductor laser, is focused on a photoconductor drum (image carrier) by a scanning optical system to form an electrostatic latent image on a surface of the photoconductor drum.

In this type of image forming apparatus, a phenomenon of reciprocity failure occurs in which, even when a total amount of light applied to the photoconductor drum is the same, a latent image formation state differs depending on the relationship between light intensity and an exposure time. That is, in a case of exposure for a very short period of time, as compared with a case of exposure over a relatively long period of time, an amount of change in potential of a photoconductor is reduced in spite of the same total exposure amount, and thus the reciprocity failure occurs. When this is applied to a multi-beam scanning optical system, the reciprocity failure appears as image density unevenness.

In order to cope with the image density unevenness caused by the reciprocity failure, a method is known in which a vertical cavity surface emitting laser (VCSEL) in which many light emitting points are arranged in a main scanning direction and a sub-scanning direction is used as a light source, and multiple exposure is performed at a certain scanning frequency or more to make density level differences invisible. However, in the related art, the number of beams, such as 32 beams, is enormous, and a driving system is complicated. Furthermore, there arises a problem in that cost is largely increased.

In order to cope with the density unevenness caused by the reciprocity failure, an image forming apparatus has been proposed in which an amount of toner to be developed on superposed lines of an m-th main scanning operation and an (m+1)-th main scanning operation is calculated and a first light intensity of the (m+1)-th scanning operation and an N-th light amount of the m-th scanning operation are adjusted to reduce an adverse effect of the reciprocity failure. However, in the related art, when electronic bow correction is performed, synchronization between density correction and bow correction cannot be easily achieved due to influence of partial magnification correction of the density correction and the bow correction and the asynchronism of a density correction circuit, and a streak image is likely to be generated at a boundary of the bow correction. In addition, highly accurate density correction in consideration of various variations cannot be easily achieved, and a density level difference is likely to occur at the boundary of the bow correction.

Furthermore, an image forming apparatus is known which corrects an image writing position by forming a registration mark and detecting a deviation amount with respect to a normal position in order to suppress color misregistration based on various causes in image formation, but this technique does not mean the bow correction itself.

### SUMMARY OF THE INVENTION

A technique has not been proposed to prevent a streak image from being generated at a boundary of bow correction when electronic bow correction is performed in an image forming apparatus. Due to the characteristics of human vision, the degree of recognition of density unevenness differs depending on the color, and a technique for preventing the occurrence of density unevenness in consideration of this point has not been proposed.

In view of such circumstances, the disclosure provides an image forming apparatus and the like capable of preventing occurrence of a streak image at a boundary of bow correction and preventing occurrence of density unevenness in which a degree of recognition varies depending on a color. Furthermore, the disclosure provides an image forming apparatus and the like capable of smoothing a density change of an image in a density smoothing process for smoothing a gradation level difference of a halftone image generated when electronic bow correction is performed.

An aspect of the disclosure provides an electrophotographic image forming apparatus that scans a surface of an image carrier with multiple beams emitted from a plurality of light emitting elements on a basis of image data of multiple colors including black, the apparatus comprising: a bow corrector that performs electronic bow correction of image data of a predetermined color other than black in accordance with a bow characteristic of black; and a density smoothing processor that smoothens a density level difference of an image of the predetermined color subjected to the bow correction by a density smoothing process.

An aspect of the disclosure provides an electrophotographic image forming apparatus that scans a surface of an image carrier with multiple beams emitted from a plurality of light emitting elements on a basis of image data, the apparatus comprising: a bow corrector that performs electronic bow correction of image data; a density smoothing processor that performs image slide on the image data subjected to the bow correction at a micro level and performs a density smoothing process; a density correction processor that performs density correction on the image data subjected to the bow correction by light intensity correction in such a manner that a density level difference does not occur in a halftone image due to an influence of reciprocity failure in an inter-face exposure segment; and one or more controllers that cause the density smoothing processor to perform processing with a grayscale cycle of a dither pattern as a cycle of a reference image slide.

According to the image forming apparatus of an aspect of the disclosure, since the electronic bow correction is performed such that the image data of the predetermined color other than black is matched with the bow characteristic of black by reversely using the bow characteristic that is difficult to be recognized due to the characteristics of human vision, density unevenness of black that is easy to be recognized does not occur. In addition, it is not necessary to increase the level of the density smoothing process or the density correction, and it is possible to obtain an excellent effect that the calculation processing load of the density correction can be reduced.

Furthermore, according to the image forming apparatus and the like according to an aspect of the disclosure, since the density smoothing process is performed by using the grayscale cycle of the dither pattern as the cycle of the reference image slide, this does not match a strengthening condition or a weakening condition, and the gradation of the pattern is not lost. As a result, excellent effects such as a smooth density change and no occurrence of a streak image are achieved.

### BRIEF DESCRIPTION OF THE DRAWINGS

FIG. 1 is an external diagram of an image forming apparatus on which an optical scanning device is mounted according to a first embodiment.

FIG. 2 is a control block diagram of the image forming apparatus and the optical scanning device.

FIG. 3 is a circuit diagram of a signal flow path of a laser emitter and a laser driver of the optical scanning device.

FIG. 4 is a diagram schematically illustrating signal processing in the optical scanning device and processing flow of cyan, magenta, and yellow image signals.

FIGS. 5A to 5E are explanatory diagrams of electronic bow correction.

FIGS. 6A and 6B are explanatory views of a side effect of the bow correction.

FIG. 7 is an image diagram of reciprocity failure for explaining a cause of a density level difference.

FIG. 8 is a grayscale image diagram for explaining the cause of the density level difference.

FIGS. 9A and 9B are explanatory diagrams of a density smoothing process and density correction.

FIG. 10 is an explanatory diagram of the density smoothing process.

FIG. 11 is an image diagram illustrating PDM shading.

FIG. 12 is an explanatory diagram of a configuration of a superposition circuit.

FIG. 13 is an explanatory diagram of a state of a change in an analog light-intensity correction signal (Vsw).

FIG. 14 is an image diagram of density unevenness of black.

FIG. 15 is an image diagram of the electronic bow correction.

FIG. 16 is a block diagram illustrating a black density correction relationship.

FIGS. 17A and 17B are explanatory diagrams of a method of calculating an inter-face (scanning overlap) exposure ratio in a vertical direction in a 1-bit mode for explaining a process of varying a light intensity correction amount; FIG. 17A is an explanatory diagram of the calculation of a match number count of inter-face exposure segments in the vertical direction and a vertical exposure ratio; and FIG. 17B is an explanatory diagram of setting values of the exposure ratio in the vertical direction corresponding to the inter-face exposure segment match number for each resolution.

FIGS. 18A and 18B are explanatory diagrams of a method of calculating an inter-face (scanning overlap) exposure ratio in a vertical direction in a 4-bit mode in consideration of a gradation level for explaining a process of varying a light intensity correction amount; FIG. 18A is an explanatory diagram of the calculation of a match number count of inter-face exposure segments in the vertical direction and a vertical exposure ratio; and FIG. 18B is an explanatory diagram of setting values of the exposure ratio in the vertical direction corresponding to the inter-face exposure segment match number.

FIG. 19 is an explanatory diagram of each pattern of an inter-face area (scanning overlap) in an oblique direction, which is adjacent exposure in the oblique direction, in the process of varying the light intensity correction amount.

FIG. 20 is a timing chart for explaining a process of varying a light intensity correction amount reflecting the concept illustrated in FIG. 19, illustrates a match number count of an inter-face exposure segment in an oblique direction and a vertical exposure ratio.

FIG. 21 is an exposure ratio setting value in an oblique direction corresponding to the match number of an inter-face exposure segment of a ratio setting value in FIG. 20.

FIGS. 22A and 22B are explanatory diagrams of a method of calculating an exposure ratio by an inter-face area in an oblique direction in consideration of a gradation level for explaining a process of varying a light intensity correction amount, in a 4-bit mode; FIG. 22A is an explanatory diagram the method of calculating an oblique exposure ratio in consideration of an oblique direction inter-face exposure segment match number count and a gradation level; and FIG. 22B illustrates setting values of the exposure ratio in the vertical direction corresponding to the inter-face exposure segment match number.

FIG. 23 is an explanatory diagram for explaining a process of varying a light intensity correction amount, and illustrates an example of final light intensity correction corresponding to final exposure ratios.

FIG. 24 is an explanatory diagram of an example of a dither pattern.

FIG. 25 is an explanatory diagram of example patterns (TONE patterns) of the density smoothing process.

FIG. 26 is an explanatory diagram of other example patterns (TONE patterns) of the density smoothing process.

### DETAILED DESCRIPTION OF THE INVENTION

Embodiments of the disclosure will now be described with reference to the accompanying drawings.

The following embodiments are examples for explaining the disclosure, and the technical scope of the invention explained in the claims is not limited to the following description.

### 1. First Embodiment

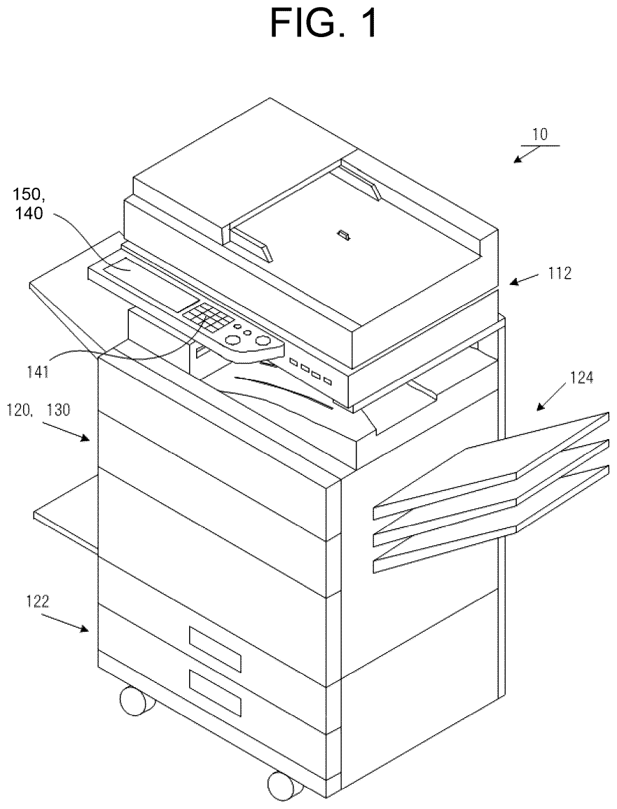

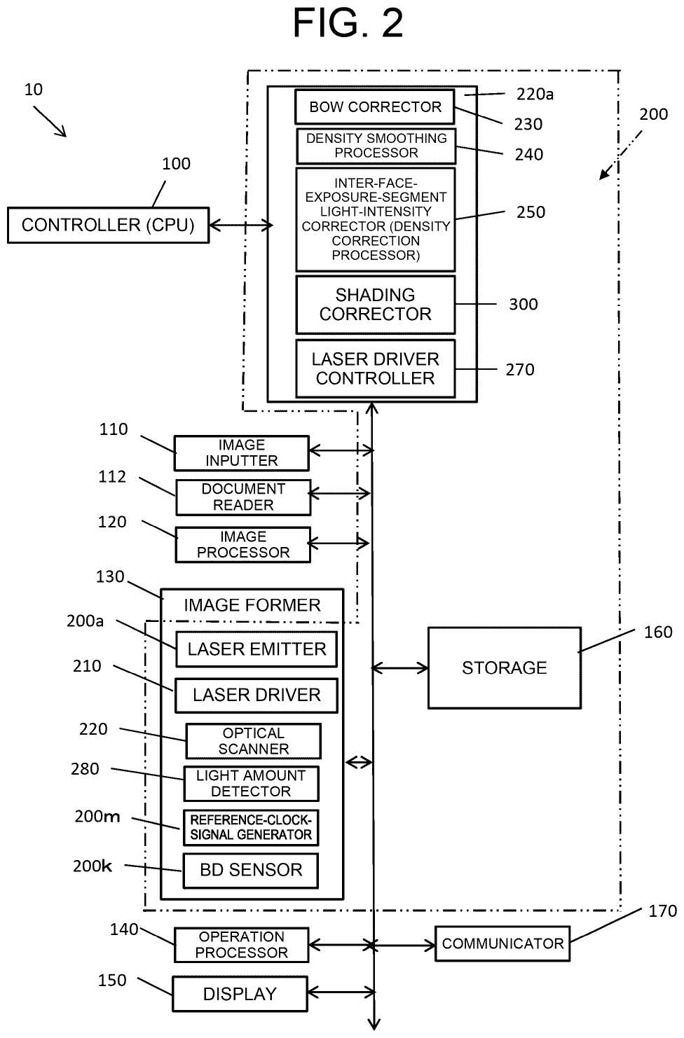

First, a configuration of an image forming apparatus 10 according to a first embodiment will be described. FIG. 1 is an external view of the image forming apparatus 10 including an optical scanning device 200 according to the first embodiment, and FIG. 2 is a block diagram for control of the image forming apparatus 10 and the optical scanning device 200.

### 1.1 Overall Configuration

As illustrated in FIG. 1, the image forming apparatus 10 is an information processing apparatus that includes a document reader 112 on the upper portion of the image forming apparatus 10 to read an image of a document and outputs the image using an electrophotographic method. An example of the image forming apparatus 10 is a multifunction printer.

As illustrated in a diagram of a control system in FIG. 2, the image forming apparatus 10 mainly includes at least one controller 100, an image inputter 110, the document reader 112, an image processor 120, an image former 130, an operation processor 140, a display 150, a storage 160, and a communicator 170, and further has a function of the optical scanning device 200.

### 1.2 Image Forming Apparatus 10

As illustrated in FIG. 2, the at least one controller 100 is a functional section for comprehensively controlling the image forming apparatus 10.

The at least one controller 100 realizes various functions by reading and executing various programs, and includes, for example, one or more arithmetic devices (for example, a central processing unit (CPU)).

The image inputter 110 is a functional section that reads image data input to the image forming apparatus 10. Moreover, the image inputter 110 is coupled to the document reader 112 being a functional section that reads an image in a document, and receives image data output from the document reader 112.

The image inputter 110 may receive image data from a storage medium, such as a USB memory or an SD card. Furthermore, the image inputter 110 may receive image data from another terminal device via the communicator 170 that performs connection to the other terminal device.

The document reader 112 has a function of optically reading a document placed on a contact glass (not illustrated), and supplying scan data to the image processor 120.

The image former 130 is a functional section that forms, on a recording medium (for example, a recording sheet), output data based on the image data. For example, as illustrated in FIG. 1, the recording sheet is fed from a paper feed tray 122, and after the image former 130 forms an image on a surface of the recording sheet, the recording sheet is output to a paper discharge tray 124. The image former 130 is composed of a laser printer that uses an electrophotography process employing an electrophotographic method.

In the electrophotographic process of the image former 130, the optical scanning device 200, described below, forms an electrostatic latent image by performing scanning with a laser beam (corresponding to laser light) corresponding to image data on a surface of a photoconductor drum (image carrier) (not illustrated), develops the electrostatic latent image with toner, and transfers and fixes the developed toner image onto a recording medium, so as to form an image.

The image processor 120 has a function of converting image data read by the document reader 112 to have a set file format (TIFF, GIF, JPEG, or the like). Then, the image processor 120 forms an output image based on the image data subjected to the image processing.

The operation processor 140 is a functional section that accepts operational instructions issued by a user, and includes various key switches and a device that detects a touch input. The user uses the operation processor 140 to input a function to be used and an output condition.

The display 150 is a functional section that displays various types of information for the user, and includes, for example, a liquid crystal display (LCD).

That is, the operation processor 140 provides a user interface for operating the image forming apparatus 10. The display 150 displays various setting menu screens of the image forming apparatus 10 and messages.

Note that, as illustrated in FIG. 1, the image forming apparatus 10 may include, as a configuration of the operation processor 140, a touch panel in which an operation panel 141 and the display 150 are integrally formed. In this case, a method for detecting an input on the touch panel may be a typical detection method, such as a resistive method, an infrared method, an electromagnetic induction method, or an electrostatic capacitive method.

The storage 160 is a functional section that stores various programs including a control program required for operation of the image forming apparatus 10, various types of data including the read data, and user information. The storage 160 includes, for example, a non-volatile read only memory (ROM), a random access memory (RAM), or a hard disk drive (HDD). Alternatively, the storage 160 may include a solid state drive (SSD), which is a semiconductor memory.

The communicator 170 performs a communication connection with an external device. A communication interface (communication I/F) used for sending and receiving data is provided as the communicator 170. With the communication I/F, data that is stored in the storage 160 of the image forming apparatus 10 may be sent to and received from any other computer device connected via a network in response to an operation performed by the user on the image forming apparatus 10.

### 1.3 Optical Scanning Device 200

As illustrated in FIG. 2, the optical scanning device 200 is mounted on the image forming apparatus 10.

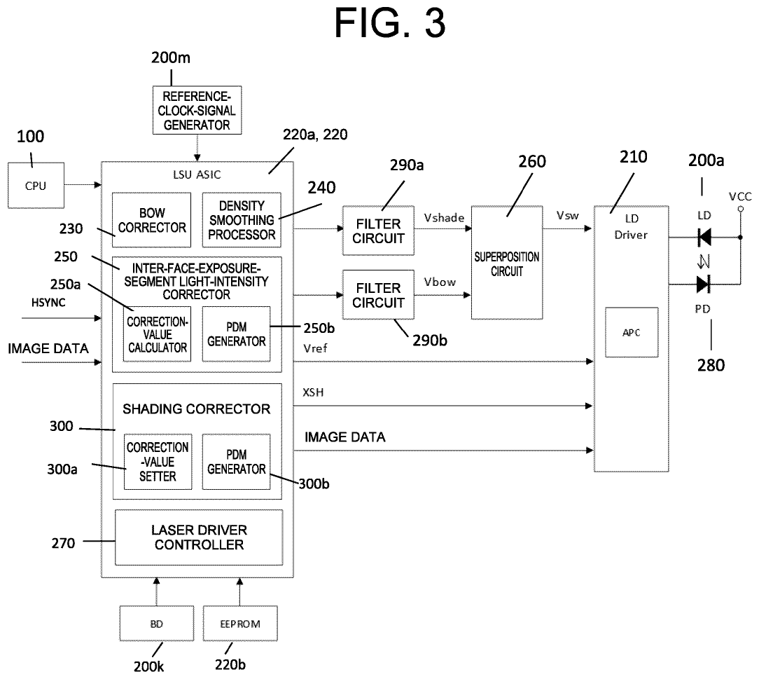

FIG. 3 is an explanatory diagram illustrating signal transmission paths from a laser scanning unit 220a to the laser driver 210 in the optical scanning device 200.

As illustrated in FIGS. 2 and 3, the optical scanning device 200 includes a laser emitter 200a that includes a plurality of laser light emitting elements (semiconductor laser devices (LDs)) and emits a plurality of laser beams (corresponding to “multiple beams”), a laser driver 210 that controls the laser emitter 200a, an optical scanner 220 that scans the photoconductor drum (not illustrated) with multiple beams emitted from the laser emitter 200a on the basis of image data, a bow corrector 230 that electronically performs bow correction on the image data, a density smoothing processor 240 that smooths a density level difference in the image subjected to the bow correction by performing the density smoothing process, a light intensity corrector (density correction processor) 250 that corrects a density level of the image subjected to the bow correction through inter-face exposure segment light-intensity correction, and a shading corrector 300 that performs a shading correction process on the image, and a laser driver controller 270 that controls light emission of a plurality of laser light emitting elements disposed on the laser emitter (LD) 200a by transmitting a control signal to the laser driver 210 on the basis of the image data subjected to the bow correction and the density smoothing process and a control signal subjected to the density correction.

The laser emitter 200a includes a plurality of laser light emitting elements, and a light intensity detector 280 including a photodiode (PD) detects the intensity of the light emitted from the laser light emitting elements.

A reference-clock-signal generator 200m generates a reference clock signal for control. A beam detect (BD) sensor 200k is disposed on a starting end side of a scanning area of a light beam and controls a timing when an electrostatic latent image is written on the photoconductor drum. Note that, in FIG. 3, Vcc denotes a power supply voltage.

As illustrated in FIG. 3, the bow corrector 230, the density smoothing processor 240, the light intensity corrector (density correction processor) 250, the shading corrector 300, and the laser driver controller 270 are realized when the laser scanning unit (LSU) 220a having an electronic control configuration mounted on the optical scanning device 200 is controlled on the basis of an instruction signal issued by the at least one controller 100. Details of the individual sections will be described later.

### 1.4 Details of Control

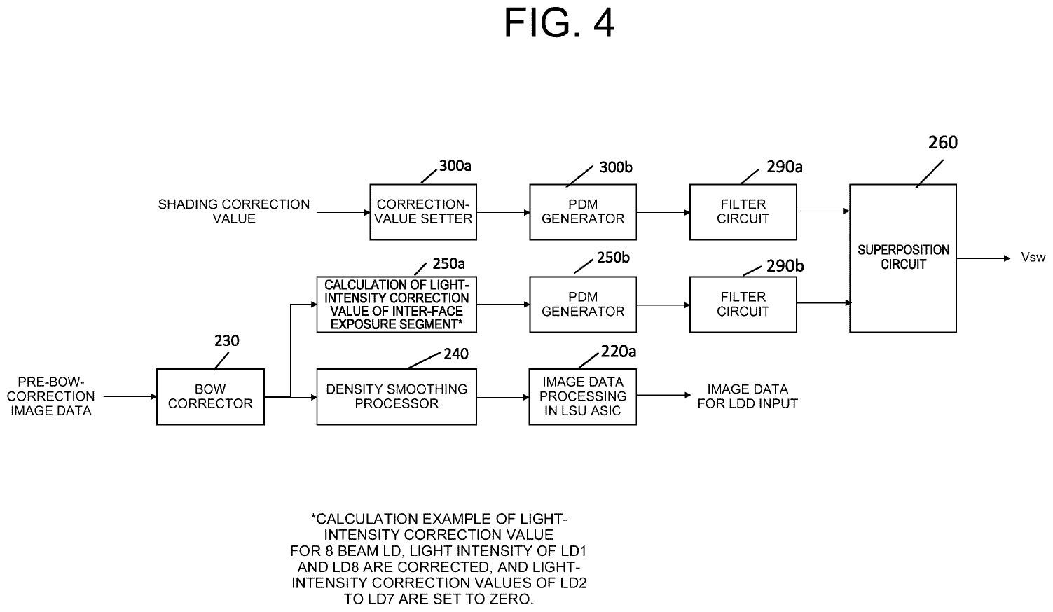

FIG. 4 is a diagram schematically illustrating signal processing and a signal flow in the optical scanning device 200.

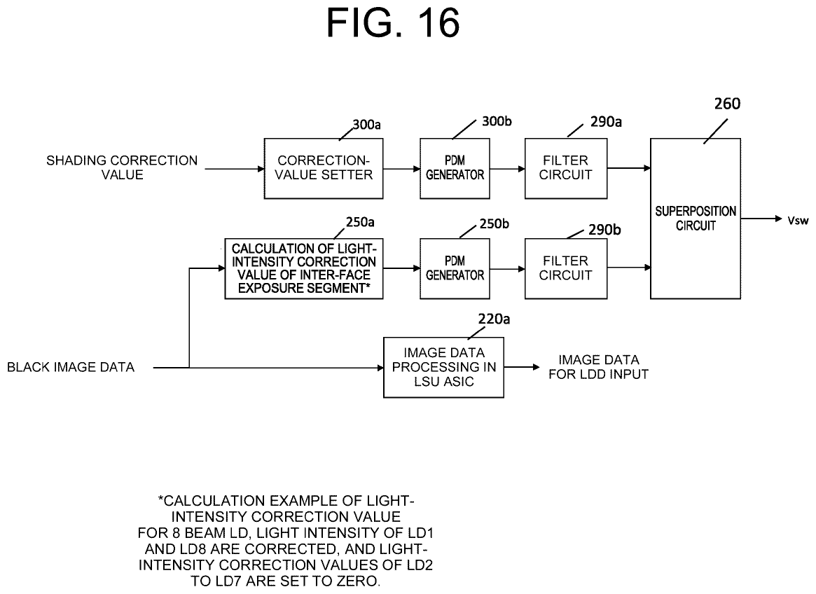

As shown in FIG. 4, the bow correction processing is not performed on the image data of black before the bow correction, and on the other hand, the bow correction processing is performed on image data of cyan, magenta, and yellow, which are predetermined colors other than black, by the bow corrector 230 in accordance with the bow characteristic of black (to be described later with reference to FIG. 15). The image after the bow correction is subjected to a density smoothing process by the density smoothing processor 240, and the processed image (image data) is subjected to predetermined processing by the laser scanning unit 220a and is input to the laser driver (LDD) 210. In the present embodiment, processing of black image data will be explained later with reference to FIG. 16 and the like.

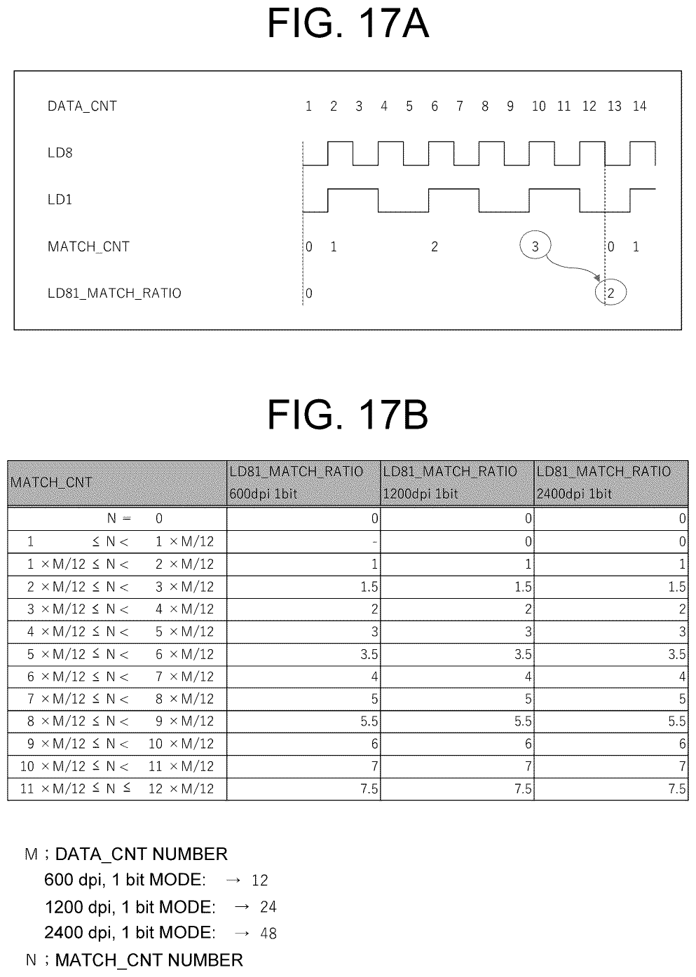

In the light intensity corrector 250, a correction value calculator 250a calculates a light-intensity correction value of an inter-face exposure segment on the basis of an image subjected to the bow correction by the bow corrector 230 (images of cyan, magenta, and yellow, which are predetermined colors other than black), a PDM generator 250b converts the light-intensity correction value into a PDM signal, a filter circuit 290b converts the light-intensity correction value into an analog signal, and then the analog signal is input to a superposition circuit 260. In addition, the bow correction is not performed on the black image, and as illustrated in FIG. 17 to be described later, the inter-face exposure segment light-intensity correction value is calculated on the basis of the black image in a state in which the bow correction is not performed.

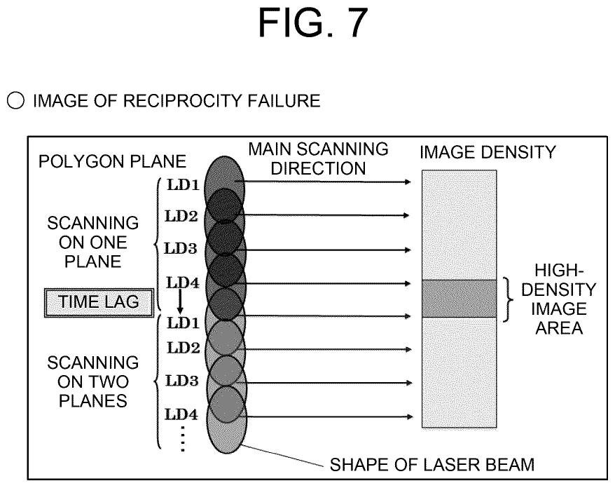

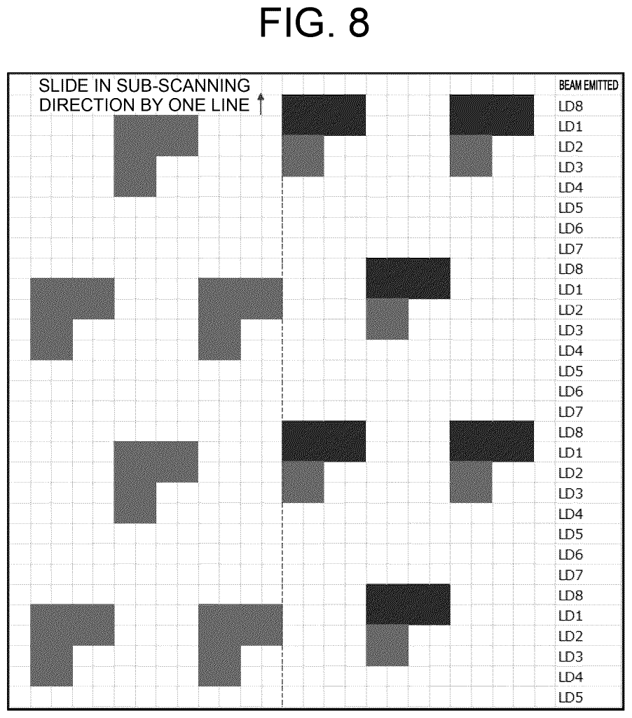

Note that, as will be described below with reference to FIGS. 7 and 8, the light-intensity correction value of the inter-face exposure segment is used to correct a phenomenon in which exposure from the end element becomes dense due to the reciprocity failure in the light emitter 200a employing a multi-beam method having a plurality of laser light emitting elements emitting light. For example, as illustrated in a column of * in FIG. 4, in a case of a laser light emitting element of eight beams (LD1 to LD8), light-intensity correction values for the light emitting elements LD1 and LD8 at end portions are calculated for the light intensity correction, and light-intensity correction values for the other light emitting elements LD2 to LD7 are zero.

In the shading corrector 300, a correction-value setter 300a sets a shading correction value obtained in advance through an experiment or the like, and a PDM generator 300b converts the shading correction value into a PDM signal and inputs the PDM signal to a filter circuit 290a. The filter circuit 290a converts the shading correction value represented by the PDM signal into an analog signal, and then input the analog signal to the superposition circuit 260. The superposition circuit 260 outputs a light-intensity correction signal (Vsw) serving as a reference signal of the laser driver 210.

Processes of the individual sections will be described in detail below.

### Electronic Bow Correction

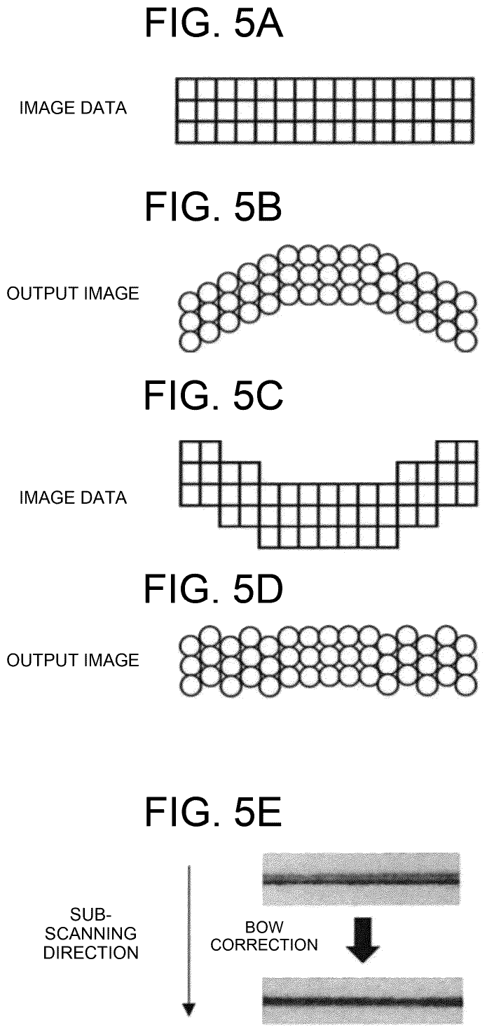

The electronic bow correction performed by the bow corrector 230 will be described with reference to FIGS. 5A to 5E. As illustrated in FIG. 5A to 5E, the electronic bow correction is a process of suppressing a color misregistration by shifting image data in a sub-scanning direction in units of segments so as to cancel out a curvature component different for each color.

Specifically, even when input image data does not have a curve in the sub-scanning direction, as illustrated in FIG. 5A, output image may have an arcuate curve in the sub-scanning direction, as illustrated in FIG. 5B, due to influence of an actual state of an optical system or the like. Therefore, the image data is subjected to the bow correction for bending the image data in an opposite direction, as illustrated in FIG. 5C, so that a linear output image is obtained, as illustrated in FIG. 5D. FIG. 5E is a diagram illustrating an example of output images before and after the bow correction.

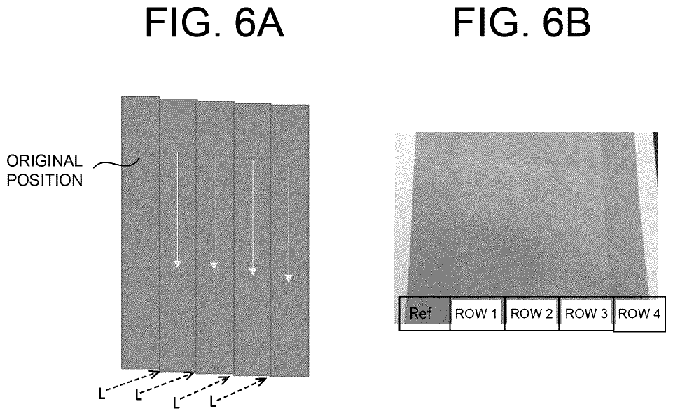

FIGS. 6A and 6B are diagrams illustrating a side effect of the bow correction. As illustrated in FIGS. 6A and 6B, since only a process of sliding an image in the sub-scanning direction in units of segments is performed, a density level difference occurs. As illustrated in FIG. 6A, a density level difference is generated only by shifting portions of the image downward by one line in the sub-scanning direction (the shift is indicated by a reference symbol L). Note that, as illustrated in FIG. 6B, the density level difference is also generated by registration adjustment in the sub-scanning direction (an example of Ref, line 1, line 2, and so on is illustrated).

FIG. 7 is an explanatory diagram of a cause of the occurrence of the density level difference. In a light emitter employing a multi-beam method including a plurality of laser light emitting elements, a phenomenon called reciprocity failure in which an area where scanning operations overlap (inter-face area) becomes dense changes a distribution in which the density becomes dense in a dither pattern, and thus the density level difference occurs.

For example, in FIG. 7, a schematic diagram of image density unevenness occurring in a multi-beam scanning system using four channels (LD1 to LD4) of semiconductor laser is illustrated. In the example of FIG. 7, an area overlapping a first face and a second face of a polygon faces in the scanning direction is an inter-face area.

During scanning, since a boundary area between LD1 and LD2 is exposed substantially at the same time, the boundary area is irradiated with light with high intensity in a short period of time. On the other hand, in a boundary area between LD4 and LD1, since LD4 is exposed first and then LD1 having a different polygon face is exposed, a time lag (time difference) occurs, and as a result, light with low intensity is applied for a long period of time. As a result of such reciprocity failure, image density in the boundary area between LD4 and LD1 is higher than those in the other portions, resulting in density unevenness.

FIG. 8 is a diagram illustrating a micro-level grayscale image of a dither pattern using multiple beams affected by the reciprocity failure. The light emitting element has an 8-beam configuration (LD1 to LD8).

According to FIG. 8, it is recognized that image density is higher in a portion overlapping a boundary area between LD8 and LD1 than in the other portions and density unevenness occurs.

### Density Smoothing Process and PDM Shading (for Bow Correction) Process

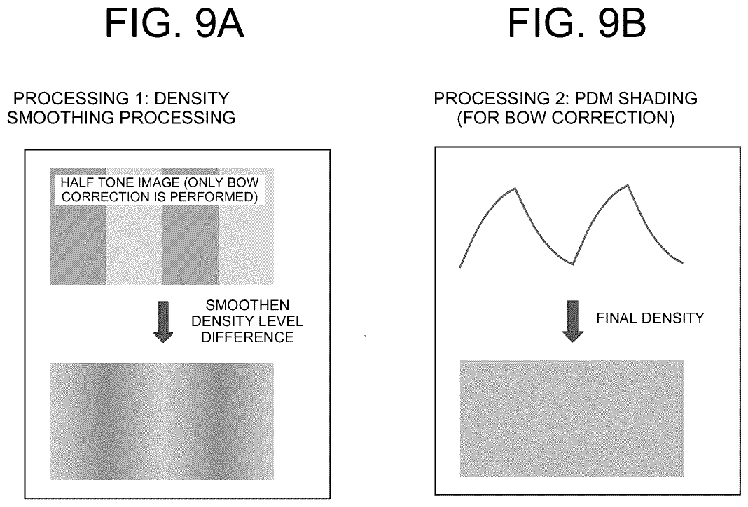

FIGS. 9A and 9B are explanatory views for smoothing a density level difference by the density smoothing process and correcting density by the shading process. As for the shading process, the density is preferably corrected by pulse density modulation (PDM) shading.

As illustrated in FIG. 9A, the density smoothing process is performed on a halftone image only subjected to the bow correction (process 1) to smooth a density level difference. As illustrated in FIG. 9B, the light intensity of the image subjected to the density smoothing process is corrected by a reverse phase, and the density correction is performed by the PDM shading process (for bow correction) (light intensity correction of an inter-face exposure segment), thereby obtaining an image of the final density without shading.

In the present embodiment, a PDM shading signal for the bow correction used for the density correction is a density correction signal based on a PDM signal set to correct light intensity so as to remove density unevenness caused by the reciprocity failure at a light emission timing of the plurality of light emitting elements. The correction of the light intensity at the light emission timing of the plurality of light emitting elements so as to remove the density unevenness caused by the reciprocity failure has the same meaning as correction of light intensity of an inter-face exposure segment.

In the light intensity correction of the inter-face exposure segment by a reverse phase, specifically, an image is output in a state in which both the bow correction and the light intensity correction are performed on the inter-face exposure segment, and a pattern of a density smoothing process which will be described below is selected so that a shading difference is eliminated. Accordingly, a phase of the light intensity correction of the inter-face exposure segment is reversed to that of the image subjected to the bow correction and the density smoothing process.

As an image of the density correction, any image is processed in the same manner according to a pattern of the density smoothing process obtained experimentally, and the light intensity correction of the inter-face exposure segment is performed according to the presence or absence of the inter-face exposure. If there is no slide in the sub-scanning direction between adjacent segments in the bow correction, the density smoothing process is practically invalid between the segments.

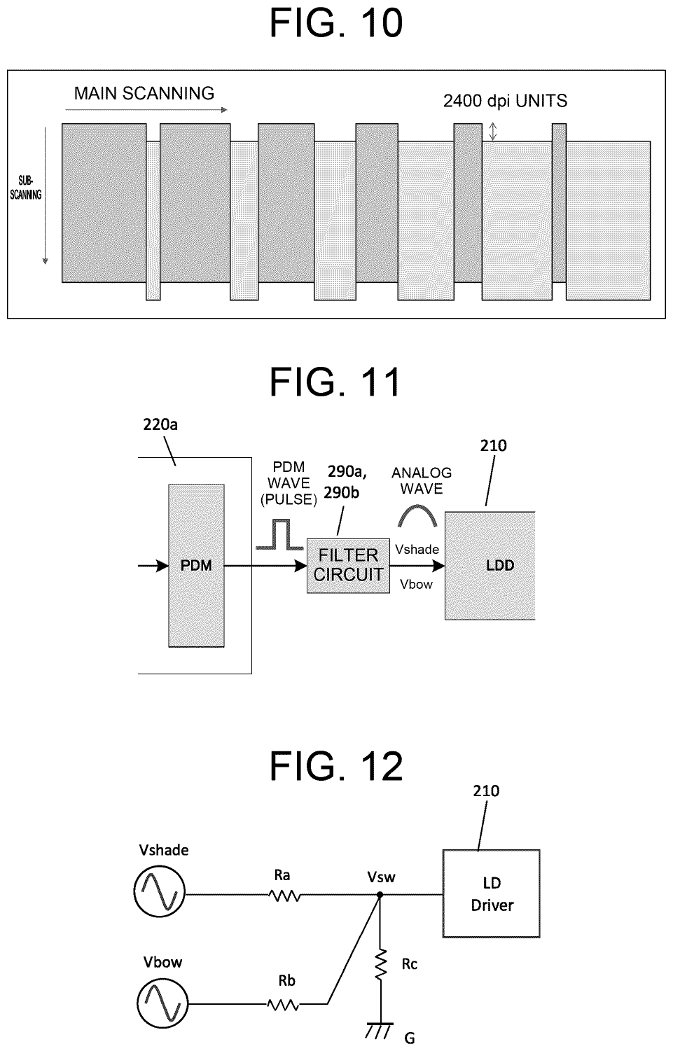

FIG. 10 is an explanatory diagram of the density smoothing process.

In the density smoothing process, as illustrated in a micro-level image of FIG. 10, an image slide is reciprocated several times at a micro-level (24000 dpi in FIG. 10) so that a density change is smoothed at a macro-level. Note that “dpi” is generally a unit of resolution, and is “dots per inch.”

When only the bow correction is performed, the following problems occur. Therefore, a streak image is likely to be generated in an item of the bow correction, and thus the density smoothing process is performed. That is, there arise problems in that synchronization between the density correction and the bow correction may not be easily achieved, highly accurate density correction considering various variations may not be easily achieved, and so on, since a portion is affected by magnification correction and asynchronism of the density correction circuit.

Here, in FIG. 3 described above, individual processes of the bow corrector 230, the density smoothing processor 240, the inter-face-exposure-segment light intensity corrector 250, and the shading corrector 300 of FIG. 2 are mainly implemented by the laser scanning unit 220a, and corresponding specific configurations will now be described.

As illustrated in FIG. 3, in the optical scanning device 200, the laser scanning unit (LSU) 220a of the optical scanner 220 is controlled by the at least one controller 100.

A reference clock signal generated by the reference-clock-signal generator 200m and a BD signal 200k are input to the laser scanning unit 220a.

In the laser scanning unit 220a, the bow corrector 230 performs the electronic bow correction process in response to a control signal supplied from the at least one controller 100. The density smoothing processor 240 performs the density smoothing process on an image subjected to the bow correction process in response to an instruction issued by the at least one controller 100. The inter-face-exposure-segment light intensity corrector 250 performs the density correction with respect to the reciprocity failure on the image subjected to the electronic bow correction performed by the bow corrector 230. The shading corrector 300 performs the shading correction process on the image. Therefore, the shading corrector 300 generates a shading correction signal Vshade, the bow corrector 230 generates a control signal (digital signal), such as a bow correction signal Vbow for the electronic bow correction, and the laser driver controller 270 controls output of control signals (such as signals for bow correction, density correction by light intensity correction of the inter-face exposure segment, and shading correction) to be input to the laser driver 210. On the basis of the control signal output from the laser driver controller 270, the laser driver 210 controls a multi-beam light emitting operation of the laser emitter 200a.

The laser scanning unit 220a is composed of an application-specific integrated circuit (LSU ASIC). The integrated circuit (LSU ASIC) of the laser scanning unit 220a receives a control signal from the at least one controller 100, image data, a horizontal synchronization signal HSYNC, a reference clock signal generated by the reference-clock-signal generator 200m, a detection signal from the beam detect (BD) sensor 200k, and the like.

The Vshade signal is an analog voltage signal for shading.

The shading corrector 300 of the laser scanning unit (LSU) 220a outputs a shading correction value read from a table (stored in a storage 220b, such as an EEPROM) set in the correction-value setter 300a as a PDM wave signal via the PDM generator 300b. The PDM wave signal of the shading correction value is converted into an analog shading voltage signal (Vshade) by an external filter circuit 290a, and is input to the superposition circuit 260. Note that the shading correction value is obtained in advance by an experiment or the like, and may be stored in the ROM or the like of the storage 160 of the image forming apparatus 10 in addition to the storage 220b.

The Vbow signal is an analog voltage signal for the bow correction.

The bow corrector 230 of the laser scanning unit (LSU) 220a outputs a bow correction PDM signal, which is converted into the analog bow correction voltage signal (Vbow) by the external filter circuit 290b and input to the superposition circuit 260.

A signal obtained by superposing the analog shading voltage signal (Vshade) and the analog bow correction voltage signal (Vbow) by the superposition circuit 260 is input to the laser driver 210 to control and correct multi-beam light emission.

The inter-face-exposure-segment light intensity corrector 250 calculates a correction value of light intensity in the inter-face exposure segment (correction value calculator 250a). The calculated light-intensity correction value is input to the laser driver 210 as a light-intensity correction signal via the PDM generator 250b and a filter circuit (not illustrated), and the multi-beam light emission is controlled and corrected by the laser driver 210.

FIG. 11 is a diagram illustrating analog conversion of a PDM signal. As illustrated in FIG. 11, a digital shading signal (PDM signal) and a digital bow correction signal (PDM signal) output from the laser scanning unit 220a are converted into an analog shading voltage signal (Vshade) and an analog bow correction signal (Vbow) by the filter circuit 290a and the filter circuit 290b, respectively.

FIG. 12 is a diagram illustrating a basic configuration of the superposition circuit 260. As illustrated in FIG. 12, the shading voltage signal (Vshade) and the bow correction signal (Vbow), which are analog voltage signals, pass through resistors Ra and Rb, respectively, and are superposed at an addition point of a ground resistor Rc to form a light-intensity correction signal (Vsw) of an analog reference signal (analog voltage signal), which is input to the laser driver 210. Note that a reference character G denotes the ground.

The light-intensity correction signal (Vsw) to be input to the laser driver 210 is obtained by the following equation (1) based on the principle of superposition of the Vshade signal and the Vbow signal performed by the superposition circuit 260 including the resistors Ra, Rb, and Rc.

$$Vsw = ( Vshade \times RbRc + Vbow \times RcRa ) / ( RaRb + RbRc + RcRa ) \qquad ( 1 )$$

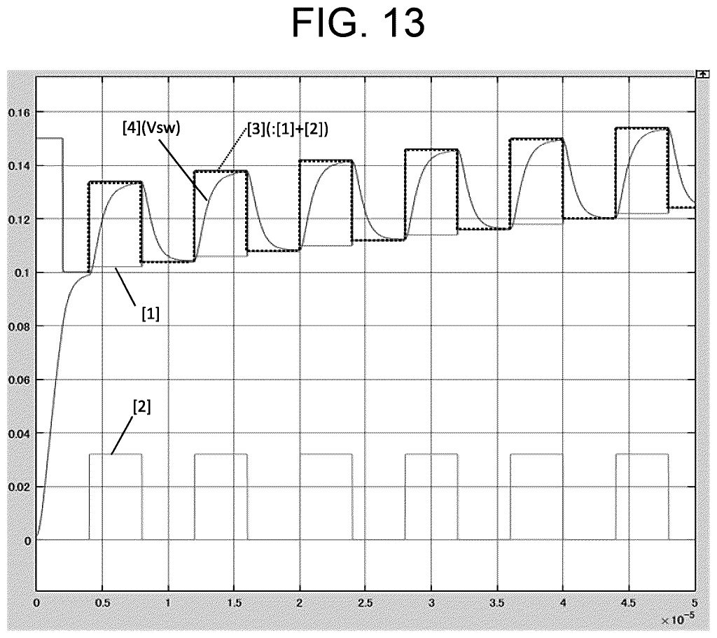

FIG. 13 is a graph illustrating a state in which the analog light-intensity correction signal (serving as an analog reference signal) (Vsw) input to the laser driver 210 changes.

In the case of FIG. 13, a simulation waveform obtained by superposing a mechanism of the PDM shading for the bow correction on a mechanism of general shading (shading setting signal) is illustrated.

In FIG. 13, a signal [1] is a general shading setting signal, a signal [2] is a bow correction PDM setting signal, a signal [3] is a combined signal obtained by adding the shading setting signal [1] and the bow correction PDM setting signal [2], and a signal [4] is an analog light-intensity correction signal (Vsw) input to the laser driver 210.

### Light Intensity Correction Amount Varying Process

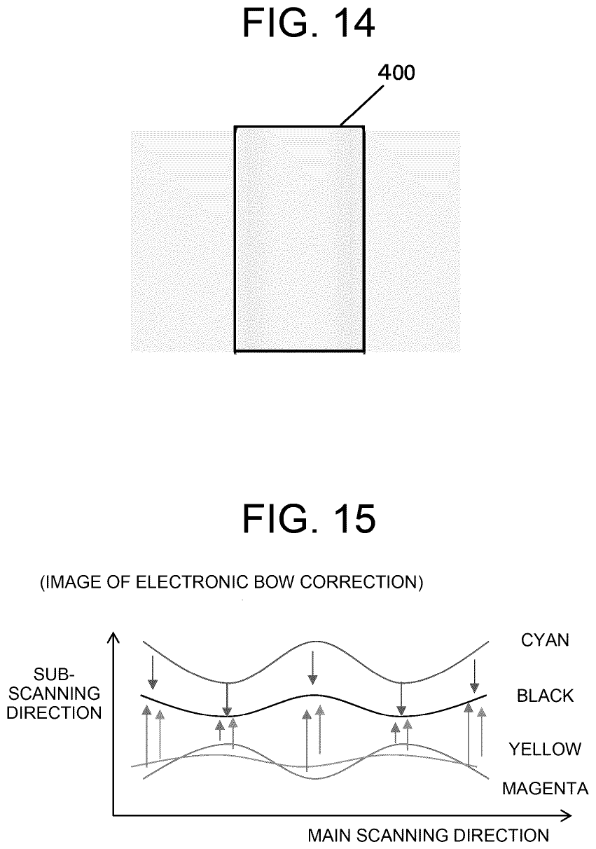

Here, the light intensity correction amount varying process will be explained with reference to FIGS. 14 to 22.

In the light intensity correction of the light intensity corrector 250 of the inter-face exposure segment, density unevenness is likely to occur for the following reasons unless the light intensity correction amount is varied.
Since the semiconductor laser LD requires time for response, correction for each of resolution/mode (1 bit/4 bit) is required in consideration of this.
Since the light intensity and the image density are not in a proportional relationship, correction for each gradation is required.
Correction in accordance with the exposure ratio (vertical/oblique direction) of scanning overlap (inter-face area) is necessary.

Therefore, in the present embodiment, the light intensity correction amount is made variable by setting the light intensity table for each of the resolution/mode (1 bit/4 bit) in accordance with the exposure ratio of the inter-face area (scanning overlap).

### Density Unevenness of Black

Black is easily recognized as density unevenness by human vision. However, the bow characteristic itself is not easily recognized. Therefore, black is not subjected to electronic bow correction, and cyan, magenta, and yellow are subjected to electronic bow correction so as to match the bow characteristic of black.

FIG. 14 is an image diagram of density unevenness of black. A portion indicated by a frame line 400 in FIG. 14 is an area originally dark generated when only the bow correction is performed. By additionally performing the density smoothing process and the density correction, the density difference in the middle area is eliminated, but the density difference is likely to remain in the areas at both ends in the frame.

### Image of Electronic Bow Correction for Cyan, Magenta, and Yellow

FIG. 15 is an image diagram of the electronic bow correction. As illustrated in FIG. 15, the bow corrector 230 does not perform the electronic bow correction for black, and performs the electronic bow correction for cyan, magenta, and yellow as indicated by arrows directed in the sub-scanning direction so as to match the bow characteristics of black.

In the present embodiment, the predetermined colors other than black may include not only cyan, magenta, and yellow but also spot colors.

### Density Correction of Black Image Data

FIG. 16 is a block diagram illustrating a black density correction relationship. The same portion as in FIG. 4 are denoted by the same reference numerals.

As illustrated in FIG. 4, the image data of cyan, magenta, and yellow other than black is subjected to the bow correction, but as illustrated in FIG. 16, the image data of black is not subjected to the bow correction and the smoothing process, and the light-intensity correction value is calculated. That is, signal processing is performed in a form excluding the bow corrector 230 and the density smoothing processor 240 in FIG. 4.

As illustrated in FIG. 16, the black image data is not subjected to the bow correction and the density smoothing process, but is subjected to a predetermined process in the laser scanning unit 220a and is inputted to the laser driver (LDD) 210.

It is provided the correction value calculator 250a that corrects the density of the bow-corrected images of cyan, magenta, and yellow other than black and the density of the black image not subjected to the bow correction by the light intensity correction of the inter-face area (scanning overlap).

In the case of the 8-beam semiconductor laser LD (LD1 to LD8), the inter-face light intensity correction corrects the light intensity of LD1 and LD8 relating to the inter-face exposure segment, and the light-intensity correction values of LD2 to LD7 are set to 0 (zero).

### Processing of Varying Light-Intensity Correction Amount Related to Density Correction of Inter-Face Exposure Segment

Next, a process of varying the light-intensity correction amount will be explained with reference to FIGS. 17 to 22.

FIGS. 17A and 17B are explanatory diagrams of a method of calculating an inter-face (scanning overlap) exposure ratio in the vertical direction in the 1 bit mode, and illustrates a case of the 600 dpi, 1200 dpi, and 2400 dpi 1 bit modes.

FIG. 17A is an explanatory diagram of the calculation of the match number count of inter-face exposure segments in the vertical direction and the vertical exposure ratio. The data counter (DATA_CNT) number in the drawing differs depending on the mode, and is indicated by the symbol “M.” In the case of 600 dpi, the data counter (DATA_CNT) number is 12.

Then, when the eighth semiconductor laser LD8 on one surface of the polygon and the first semiconductor laser LD1 on the next surface simultaneously become 1 in the vertical direction, the counter of the number of matches (MATCH_CNT) is incremented by 1, and the vertical exposure ratio is calculated for each area. In the case of the drawing, when the number of the date counter (DATA_CNT) is 12, the number of the match number counter (MATCH_CNT) becomes 3, and the vertical exposure ratio setting value of LD8/LD1 becomes 2 for LD81_MATCH_RATIO.

FIG. 17B is an explanatory diagram of setting values of the exposure ratio in the vertical direction corresponding to the inter-face exposure segment match number for each resolution. As illustrated in FIG. 17B, the processing is generalized so that the calculation method does not change depending on the resolution, and the ratio setting value (LD81_MATCH_RATIO) corresponding to the counter (MATCH_CNT) of the number of matches is set for each of the resolutions (600 dpi, 1200 dpi, and 2400 dpi).

In FIGS. 17A and 17B, symbols M and N mean the following.
M: DATA_CNT number
600 dpi, 1-bit mode: 12
1200 dpi, 1-bit mode: 24
2400 dpi, 1-bit mode: 48
N: MATCH_CNT number

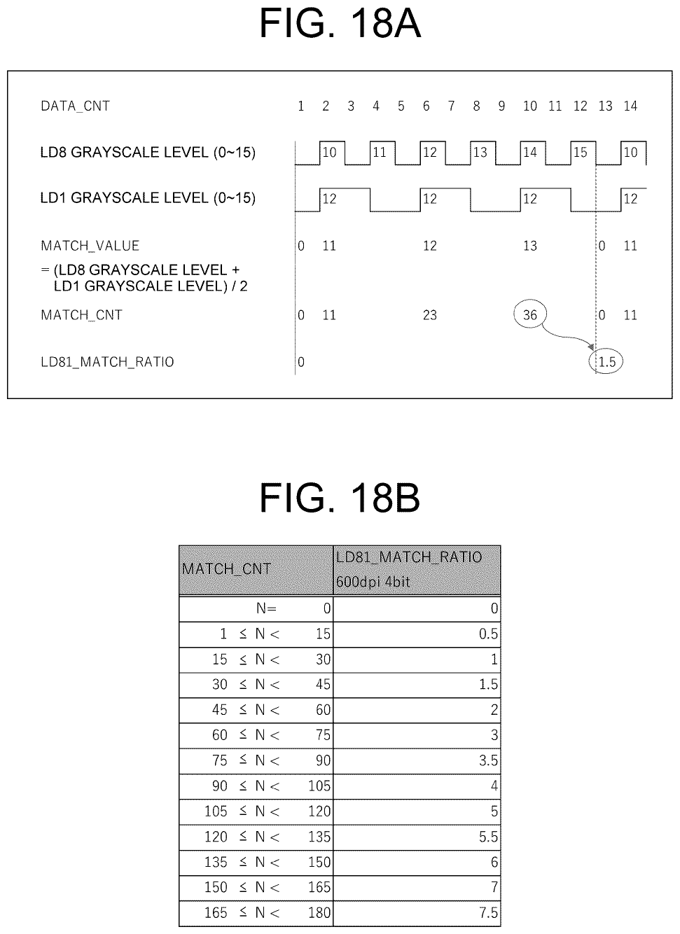

Next, FIGS. 18A and 18B illustrate a case of 4-bit mode at 600 dpi in the processing of varying the light intensity correction amount. FIGS. 18A and 18B are an explanatory diagram of a method of calculating an inter-face (scanning overlap) exposure ratio setting value (LD81_MATCH_RATIO) in the vertical direction for each area by performing addition in consideration of a gradation level in this case.

Mean values of the grayscale levels (0 to 15) of the eighth semiconductor laser LD8 and the grayscale levels (0 to 15) of the first semiconductor laser LD8 are calculated by the following equation (2).

MATCH_VALUE=(LD8 gradation level+LD1 gradation level)/2 (2)

The calculated grayscale levels MATCH_VALUE are added to obtain a match number count MATCH_CNT.

Then, on the basis of the correction table in FIG. 18B, the exposure ratio setting value (LD81_MATCH_RATIO) is calculated from the match number count MATCH_CNT of the inter-face exposure segments. In this case, it is 600 dpi 4 bit. As illustrated in FIG. 18A, MATCH_CNT obtained by adding MATCH_VALUE is “36,” and from FIG. 18B, the exposure ratio setting value (LD81_MATCH_RATIO) becomes “1.5.”

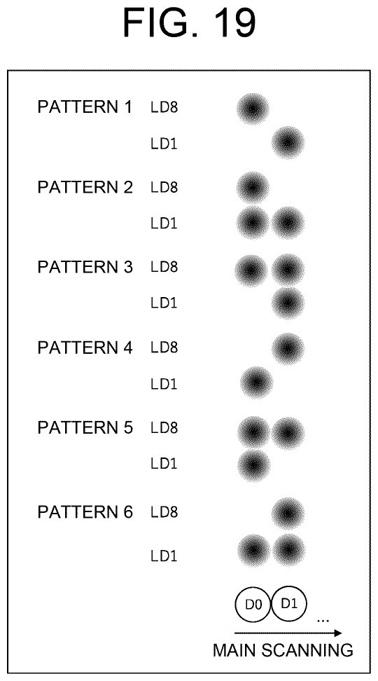

Next, FIG. 19 is an explanatory diagram of each pattern of an inter-face area (scanning overlap) in an oblique direction, which is adjacent exposure in the oblique direction in the process of varying the light intensity correction amount. FIG. 19A is a diagram illustrating an adjacent state in an oblique direction, and FIG. 19B is a diagram illustrating a counting method.

Not only the vertical exposure by the eighth semiconductor laser LD8 and the first semiconductor laser LD1, but also the adjacent exposure in the oblique direction may be affected by the reciprocity failure, and therefore, the exposure is counted separately from the vertical exposure.

As a counting method, as shown in Table 1, the counter value is incremented according to a pattern in which the exposure positions of the semiconductor lasers LD8 and LD1 are at the position of D0 or D1 in the main scanning direction.

TABLE 1
(Counting method)
Up the count value at the time corresponding to the pattern in the figure.

| | |
|---|---|
| Pattern 1: | LD8_D0 · L̅D̅1̅_̅D̅0̅ · L̅D̅8̅_̅D̅1̅ · LD1_D1 = 1 |
| Pattern 2: | LD8_D0 · LD1_D0 · L̅D̅8̅_̅D̅1̅ · LD1_D1 = 1 |
| Pattern 3: | LD8_D0 · L̅D̅1̅_̅D̅0̅ · LD8_D1 · LD1_D1 = 1 |
| Pattern 4: | L̅D̅8̅_̅D̅0̅ · LD1_D0 · LD8_D1 · L̅D̅1̅_̅D̅1̅ = 1 |
| Pattern 5: | LD8_D0 · LD1_D0 · LD8_D1 · L̅D̅1̅_̅D̅1̅ = 1 |
| Pattern 6: | L̅D̅8̅_̅D̅0̅ · LD1_D0 · LD8_D1 · LD1_D1 = 1 |

For example in pattern 1 illustrated in FIG. 19, LD8_D0 and LD8_D1 indicate conditions for the semiconductor laser LD8 to irradiate the positions D0 and D1, respectively, and LD1_D0 and LD1_D1 indicate conditions for the semiconductor laser LD1 to irradiate the positions D0 and D1, respectively, and if each condition is met, “1” will be determined, and if not, “0” will be determined.
The condition of non-irradiation is indicated by putting a bar over characters (over-bar), and so for example, the condition of LD8 not irradiating the position D0 is indicated by L̅D̅8̅_̅D̅0̅, and the condition of LD1 not irradiating the position D0 is indicated by L̅D̅1̅_̅D̅0̅. If the condition is met, “1” will be determined, and if not, “0” will be determined.

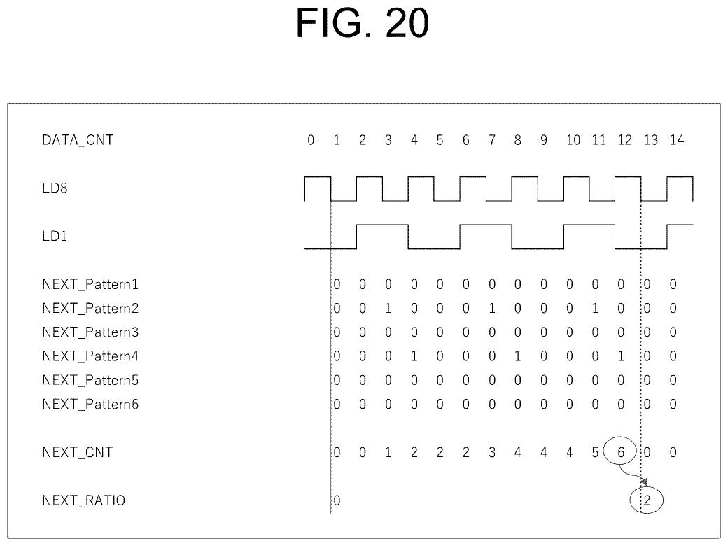

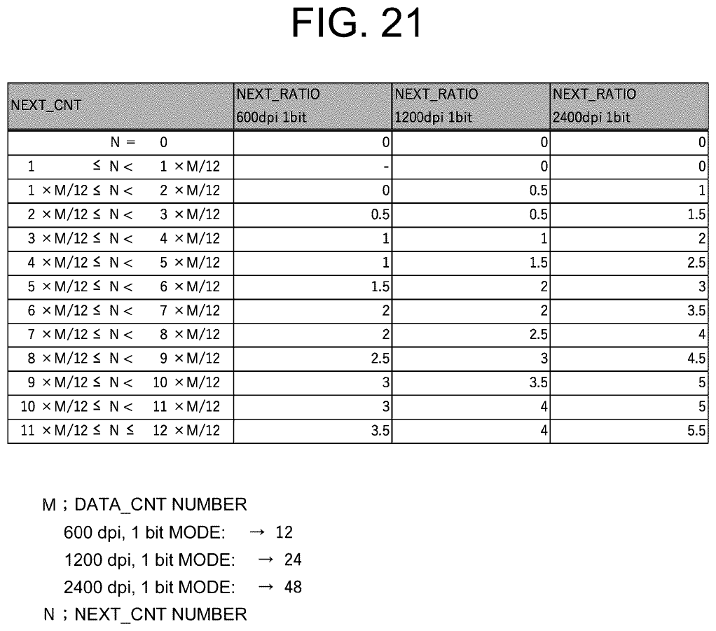

FIG. 20 is a timing chart for explaining the light intensity correction amount varying process that reflects the concept of the patterns illustrated in FIG. 19. In the case of the 1 bit mode, the inter-face exposure segment match number count in the oblique direction and the vertical exposure ratio are illustrated. FIG. 21 illustrates setting values of the exposure ratio in the vertical direction in accordance with the inter-face exposure segment match number. They are set for each of resolutions of 600 dpi, 1200 dpi, and 2400 dpi.

Match/mismatch with the patterns 1 to 6 of FIG. 19 is indicated by 1/0 in NEXT_Pattern1 to NEXT_Pattern6 of FIG. 20. The total values in the counter number DATA_CNT of NEXT_Pattern1 to NEXT_Pattern6 are expressed in NEXT_CNT.

As for the NEXT_RATIO calculation method, as illustrated in FIG. 21, ratio setting values (RATIO and NEXT_RATIO) corresponding to the match numbers are set for respective resolutions, as in the case of MATCH_RATIO in FIG. 17. In FIGS. 20 and 21, symbols M and N mean the following.
M: DATA_CNT number
600 dpi, 1-bit mode: 12
1200 dpi, 1-bit mode: 24
2400 dpi, 1-bit mode: 48
N: NEXT_CNT number

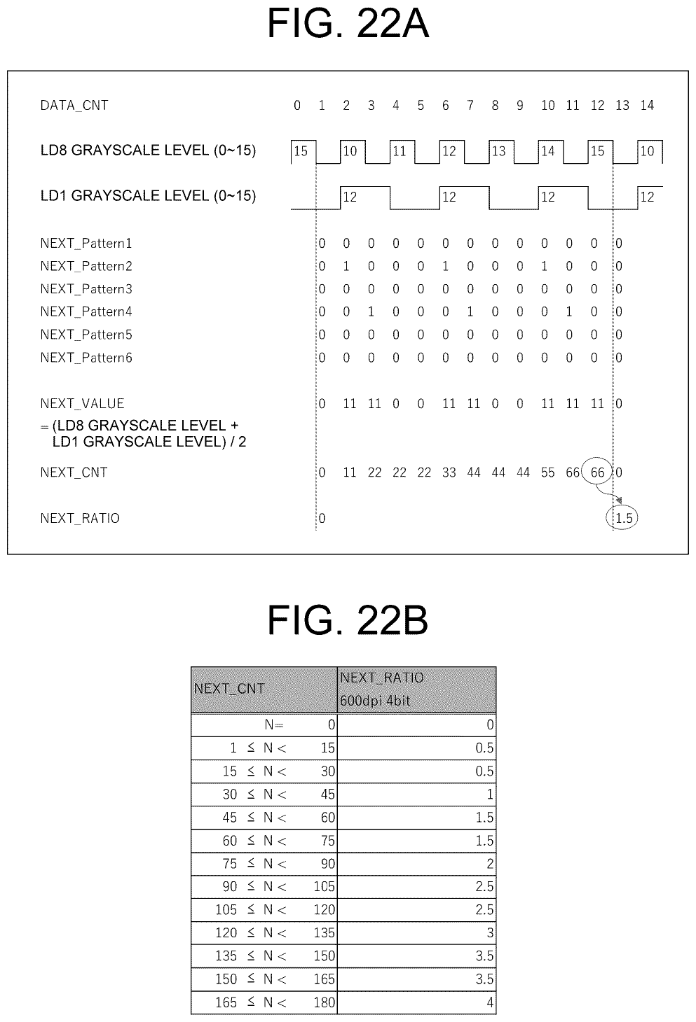

FIGS. 22A and 22B are explanatory diagrams of a method of calculating an exposure ratio by an inter-face area in an oblique direction in consideration of a gradation level for explaining a process of varying a light intensity correction amount, and are explanatory diagrams of an oblique exposure ratio in consideration of an oblique direction inter-face exposure segment match number count and a gradation level in a case of the 4-bit mode.

As illustrated in FIG. 22A, the mean value NEXT_VALUE of the grayscale levels of the semiconductor lasers LD8 and LD1 is calculated from the following equation (3).

NEXT_VALUE=(LD8 grayscale level+LD1 grayscale level)/2 (3)

Since the match number count NEXT_CNT takes the gradation level into consideration, the match number count NEXT_CNT is obtained by adding the value of the mean value NEXT_VALUE of the grayscale level obtained by equation (3) every time the count value DATA_CNT is incremented by 12.

As illustrated in FIG. 22B, a setting value (NEXT_RATIO) of the exposure ratio in the vertical direction corresponding to the inter-face exposure segment match number (match number count NEXT_CNT) is obtained, and thereby the oblique exposure ratio for each area is calculated. In the example of FIG. 22A, since the match number count NEXT_CNT is “66,” the setting value NEXT_RATIO of the exposure ratio is calculated to be “1.5.”

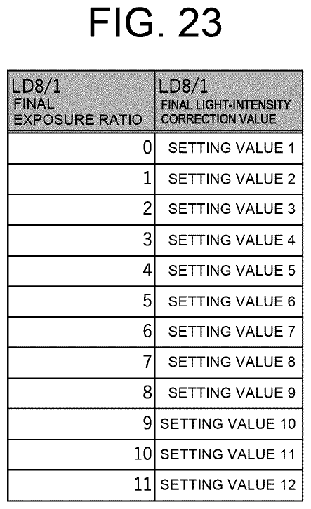

Next, FIG. 23 illustrates a process of varying an inter-face exposure light intensity correction amount, and is an explanatory diagram of an example of a final light intensity correction amount with respect to a final exposure ratio.

In the present embodiment, the setting values of the exposure ratios in the vertical direction and the oblique direction are added as in the following equation (4), and the final inter-face exposure ratio is calculated.

Final exposure ratio=vertical exposure ratio+oblique exposure ratio (4)

Finally, the light intensity correction amount corresponding to the inter-face exposure ratio is set. In FIG. 23, final light-intensity correction values for the final exposure ratios of LD8 and LD1 are set. When a final exposure ratio has a decimal point, it is rounded off. Furthermore, when a final exposure ratio exceeds 11 dec, rounding processing is performed to round the final exposure ratio to 11 dec.

### 2. Second Embodiment

In the second embodiment, description of the same points as those in the first embodiment will be omitted as appropriate, and different points will be mainly described. In the second embodiment, the density smoothing processor 240 performs image slide at a micro level to the image data subjected to bow correction and performs a density smoothing process; the light intensity corrector (density correction processor) 250 corrects the density of bow corrected image data by light intensity correction so as not to generate a density level difference in a halftone image by receiving the influence of reciprocity failure in an inter-face exposure segment; the at least one controller 100 smoothens the density level difference of the image by controlling a density smoothing processor 240 in accordance with the change rate of the density correction of the density correction processor 250, and causes the density smoothing processor 240 to execute processing with the grayscale cycle of a dither pattern as the cycle of a reference image slide; and the shading corrector 300 performs a shading correction process on the image.

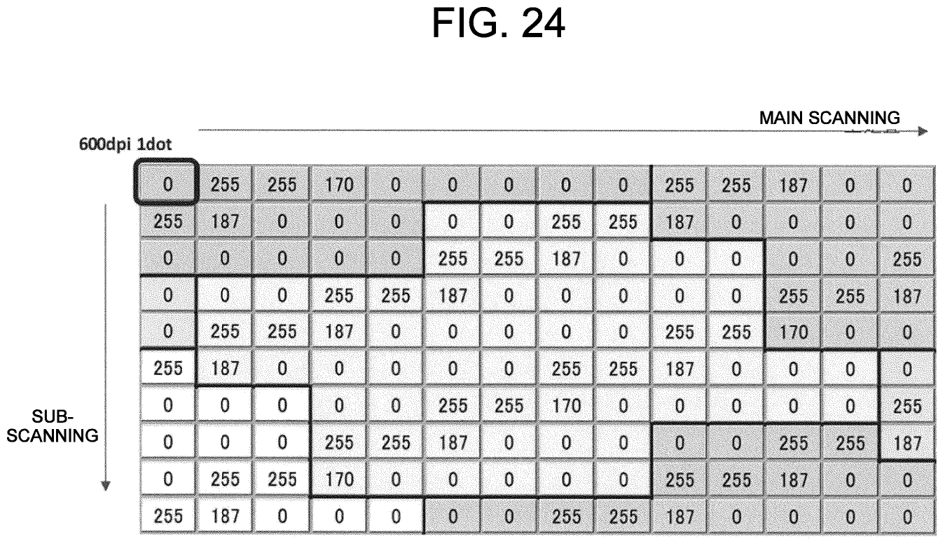

FIG. 24 illustrates an example of a dither pattern, specifically, an example of a pattern at the time of a 600 dpi, 4-bit mode, line dither, and an input value 170.

Here, the value of each cell is 600 dpi, which indicates the duty ratio at the time of 1 dot, 255 is the MAX value, and 0 is the MIN value. Considering the division in the main scanning direction, a combination of 255 and 255/187 or a combination of 255 and 255/170 is generated, and the formation of a dark dot and the formation of a light dot are repeated for each 1 dot.

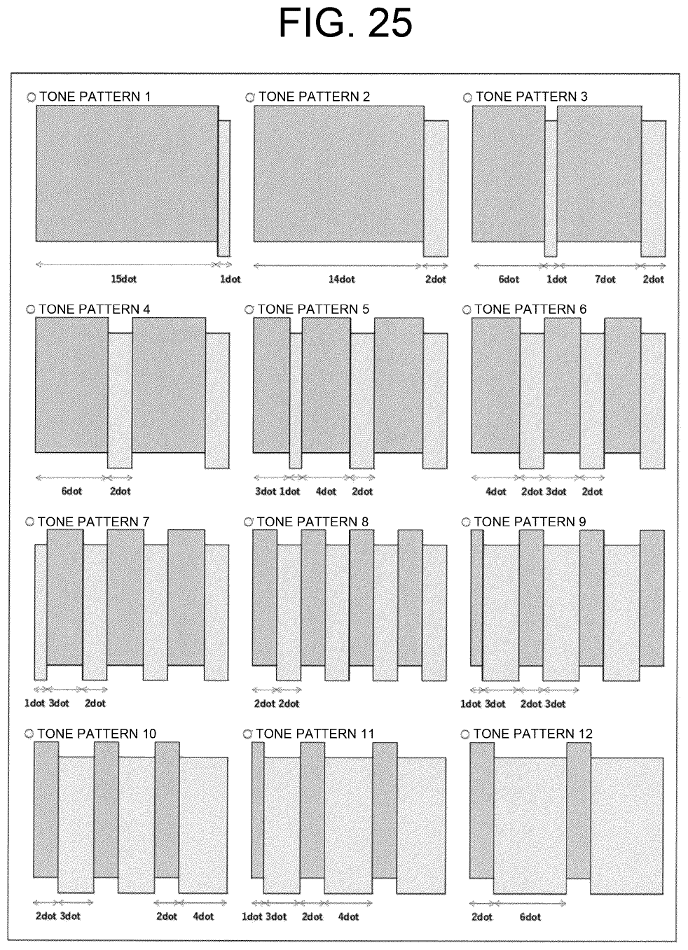

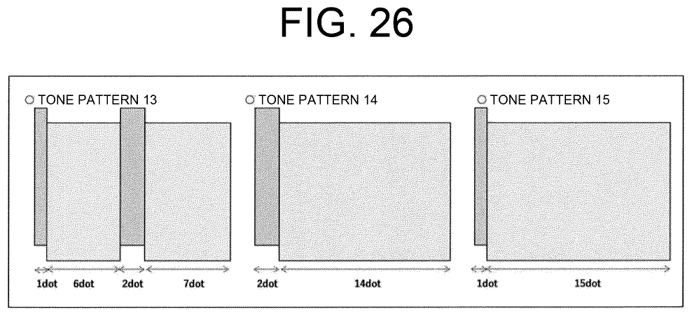

FIGS. 25 and 26 illustrates examples of patterns of the density smoothing process. The density smoothing process is performed by the density smoothing processor 240 in units of 600 dpi to select which of the patterns illustrated in FIGS. 25 and 26 are to be performed in which order in response to an instruction issued by the at least one controller 100.

That is, as described above with reference to FIG. 9, the density smoothing processor 240 of the present embodiment reciprocates image slide several times at a micro level to smoothen a density change at the micro level, the at least one controller 100 controls a selection of a pattern to be used in the density smoothing process of the density smoothing processor 240 in accordance with a change rate of the density correction of the inter-face exposure segment light intensity corrector 250, thereby smoothening the density level difference of the image in accordance with the density change.

As described above, the reason why the density smoothing process is performed is to cope with problems, such as a case where synchronization between the density correction and the bow correction cannot be easily achieved due to the influence of magnification correction and asynchronism of a density correction circuit on a portion, and a case where highly accurate density correction considering various variations cannot be easily achieved. However, when only the density smoothing process is uniformly performed using a single pattern as illustrated in FIG. 9, density unevenness may occur at the micro level in an image having different density change rates.

Therefore, in the present embodiment, in order to prevent the density unevenness caused by the density smoothing process, a pattern corresponding to the density change rate is appropriately selected from the plurality of patterns for the density smoothing process to prevent the density unevenness.

Here, when the reference of the slide cycle of the dither pattern is ½ of the grayscale cycle of the dither pattern, as illustrated in FIG. 10, in some cases, this coincides with the strengthening condition or the weakening condition of the density, and the gradation of the TONE pattern is lost.

Therefore, in the present embodiment, the density smoothing process is performed using the grayscale cycle of the dither pattern as a reference image slide cycle.

Therefore, since the reference of the image slide cycle is not set to ½ of the grayscale cycle of the dither pattern, this does not coincide with the condition for strengthening the grayscale, and the gradation of the TONE pattern is not lost. As a result, a smooth density change is obtained, and no streak image is generated.

The TONE patterns illustrated in FIGS. 25 and 26 are performed in 600 dpi units, and which pattern is to be performed how many times in which order are arbitrarily selected.

In the example of the present embodiment, as illustrated in FIGS. 25 and 26, 15 types of patterns (TONE patterns 1 to 15) of the density smoothing process are prepared. Each of the TONE patterns 1 to 15 is a pattern slid in the sub-scanning direction with respect to a non-slide area appropriately selected from image areas obtained by dividing 16 dots in total in the main scanning direction into one or more areas in the main scanning direction with various dot widths.

Each TONE pattern will be described. The slide direction is the sub-scanning direction, and the arrangement direction of the areas is the main scanning direction in the description with reference to FIG. 10.

As illustrated in FIG. 25, in the TONE pattern 1, a 1-dot slide area adjacent to a 15-dot non-slide area.

In the TONE pattern 2, a 2-dot slide area is adjacent to a 14-dot slide area.

In the TONE pattern 3, a 1-dot slide area is adjacent to a 6-dot non-slide area, and further a 7-dot non-slide and a 2-dot slide area are adjacent thereto.

In the TONE pattern 4, a 2-dot slide area is adjacent to a 6-dot non-slide area, and further a 6-dot non-slide area and a 2-dot slide area are adjacent thereto.

In the TONE pattern 5, a 1-dot slide area is adjacent to a 5-dot non-slide area, and further a 4-dot non-slide area, a 2-dot slide area, a 4-dot non-slide area, and a 2-dot slide area are arranged side by side in this order.

In the TONE pattern 6, a 2-dot slide area is adjacent to a 4-dot non-slide area, and further a 3-dot non-slide area, a 2-dot slide area, a 3-dot non-slide area, and a 2-dot slide area are arranged side by side in this order.

In the TONE pattern 7, a 1-dot slide area is adjacent to a 3-dot non-slide area, and further a 2-dot slide area, a 3-dot non-slide area, a 2-dot slide area, a 3-dot non-slide area, and a 2-dot slide area are arranged side by side in this order.

In the TONE pattern 8, a 2-dot slide area is adjacent to a 2-dot non-slide area, and further a 2-dot non-slide area, a 2-dot slide area, a 2-dot non-slide area, a 2-dot slide area, a 2-dot non-slide area, and a 2-dot slide area are arranged side by side in this order.

In the TONE pattern 9, a 3-dot slide area is adjacent to a 1-dot non-slide area, and further a 2-dot non-slide area, a 3-dot slide area, a 2-dot non-slide area, a 3-dot slide area, and a 3-dot non-slide area are arranged side by side in this order.

In the TONE pattern 10, a 3-dot slide area is adjacent to a 2-dot non-slide area, and further a 2-dot non-slide area, a 3-dot slide area, a 2-dot non-slide area, and a 4-dot slide area are arranged side by side in this order.

In the TONE pattern 11, a 3-dot slide area is adjacent to a 1-dot non-slide area, and further a 2-dot non-slide area, a 4-dot slide area, a 2-dot non-slide area, and a 4-dot slide area are arranged side by side in this order.

In the TONE pattern 12, a 6-dot slide area is adjacent to a 2-dot non-slide area, and further a 2-dot non-slide area and a 6-dot slide area are adjacent thereto.

As illustrated in FIG. 26, in the TONE pattern 13, a 6-dot slide area is adjacent to a 1-dot non-slide area, and further a 2-dot non-slide area and a 7-dot slide area are adjacent thereto.

In the TONE pattern 14, a 14-dot slide area is adjacent to a 2-dot non-slide area.

In the TONE pattern 15, a 15-dot slide area is adjacent to a 1-dot non-slide area.

In the present embodiment, the at least one controller 100 cause the density smoothing processor 240 to perform processing using the TONE patterns illustrated in FIGS. 25 and 26, with the grayscale cycle of the dither pattern as the cycle of the reference image slide.

[1] First, in consideration of a dither pattern in which a dark dot formation and a light dot formation are alternated every 1 dot, a reference of an image slide cycle is set to a 2-dot unit. The TONE patterns 2, 4, 8, 12, and 14 correspond to the case where the reference of the image slide cycle is set to the 2-dot unit.

When the reference of the image slide cycle is ½of the grayscale cycle of the dither pattern, this coincides with the strengthening condition or the weakening condition of the density, and in some cases, the gradation of the TONE pattern is lost. As a result, a smooth density change does not occur, and a streak image is likely to occur. In contrast, when the image slide cycle is set to be large, shading is likely to occur at a large cycle.

Therefore, the reference of the image slide cycle is set to a 2-dot unit.

[2] In the density smoothing process of [1], the image slide cycle larger than the reference of the image slide cycle includes an odd number cycle.

This corresponds to the TONE patterns 6 and 10.

In this way, the gradation of the TONE pattern can be increased, and the density change due to the density smoothing process can be made smoother.

[3] The cycle of the minimum image slide in [2] is set to be shorter than the cycle of the reference slide.

This corresponds to the TONE patterns 1, 3, 5, 7, 9, 11, 13, and 15.

In this way, the gradation of the TONE pattern can be increased, and the density change due to the density smoothing process can be made smoother.

The TONE patterns of the present embodiment are examples, and other TONE patterns may be set. For example, the number of dots in the main scanning direction and the dot width may be modified and set to other values.

According to the present embodiment, since the density smoothing process is performed in accordance with the change rate of the density correction value, it is possible to suppress density unevenness in the density smoothing area.

As in [1], since the reference of the image slide cycle is not set to ½ of the grayscale cycle of the dither pattern, this does not coincide with the condition for strengthening or weakening the density, and the gradation of the TONE pattern is not lost. As a result, a smooth density change is obtained, and no streak image is generated.

As described in [2], by including an image slide cycle of an odd number in the image slide cycles larger than the reference of the image slide cycle, the gradation of the TONE patterns can be increased, and the density change by the density smoothing process can be made smoother.

As described in [3], since the minimum slide cycle is smaller than the reference slide cycle, the gradation of the TONE pattern can be increased, and the density change by the density smoothing process can be made smoother.

Although the embodiments have been described above, specific configurations are not limited to the embodiments, and designs and the like within the scope not departing from the gist of the present disclosure are also included in the scope of the claims.

Furthermore, the program that operates in each device in the embodiments is a program that controls a CPU or the like (a program that causes a computer to function) in a manner to realize the functions of the above embodiments. Moreover, information handled by these devices is temporarily stored in a temporary storage device (for example, a RAM) when being processed, and then stored in various storage devices, such as a ROM and an HDD, where the information is read, corrected, and written by the CPU as needed.

Here, a recording medium for storing the program may be any non-transitory recording medium, such as a semiconductor medium (for example, a ROM or a nonvolatile memory card), an optical recording medium, such as an optical recording medium or a magneto-optical recording medium (for example, a digital versatile disc (DVD), a magneto optical disc (MO), a mini disc (MD), a compact disc (CD), or a Blu-ray (registered trademark) disc), or a magnetic recording medium (for example, a magnetic tape or a flexible disk).

Furthermore, the functions of the disclosure may also be realized not only by executing the loaded programs but also processing in cooperation with the operating system, other application programs, or the like in accordance with the instructions of the programs.

Furthermore, in the case of distribution of the program to the market, the program can be stored and distributed in a portable storage device, or transferred to a server computer connected via a network, such as the Internet. In this case, a storage device of the server computer is also included in the present disclosure as a matter of course.

In addition, some or all of the devices in the above-described embodiments may be realized as large scale integration (LSI), which is typically an integrated circuit. Each functional block of each device may be individually integrated into each chip, or may be partially or fully integrated into a chip. The integrated circuit method is not limited to LSI, but can be realized by dedicated circuits or general-purpose processors. In addition, when a technology for achieving the integrated circuit which substitutes for the LSI emerges as a result of the progress of the semiconductor technology, it is of course possible to use an integrated circuit based on such a technology.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An electrophotographic image forming apparatus that scans a surface of an image carrier with multiple beams emitted from a plurality of light emitting elements on a basis of image data of multiple colors including black, the apparatus comprising:
a bow corrector that performs electronic bow correction of image data of a predetermined color other than black in accordance with a bow characteristic of black; and
a density smoothing processor that smoothens a density level difference of an image of the predetermined color subjected to the bow correction by a density smoothing process.

2. The image forming apparatus according to claim 1, wherein
the predetermined color is cyan, magenta, and yellow, and
the image forming apparatus includes one or more controllers that perform electronic bow correction only on image data of cyan, magenta, and yellow, other than black, to match the image data to a bow characteristic of black without performing bow correction on the image data of black.

3. The image forming apparatus according to claim 1, further comprising a density correction processor that performs density correction on an image of the predetermined color subjected to the bow correction and an image of black not subjected to the bow correction by inter-face light intensity correction.

4. An electrophotographic image forming apparatus that scans a surface of an image carrier with multiple beams emitted from a plurality of light emitting elements on a basis of image data of multiple colors including black, the apparatus comprising:
a density correction processor that performs density correction of an image by inter-face light intensity correction; and
one or more controllers that change a light intensity correction amount of the density correction processor in accordance with a distribution state of inter-face exposure segments.

5. The image forming apparatus according to claim 4, wherein the one or more controllers calculate, for each area, an exposure ratio of an inter-face exposure segment in a vertical direction for each resolution or mode, and changes the light intensity correction amount on a basis of the calculated exposure ratio.

6. The image forming apparatus according to claim 4, wherein the one or more controllers calculate, for each area, an exposure ratio of an inter-face exposure segment in an oblique direction for each resolution or mode, and changes the light intensity correction amount on a basis of the calculated exposure ratio.

7. The image forming apparatus according to claim 4, wherein the one or more controllers calculate a scanning overlap exposure ratio on a basis of a result obtained by adding a setting value for calculating the exposure ratio of an inter-face exposure segment in a vertical direction and a setting value for calculating the exposure ratio of an inter-face exposure segment in an oblique direction, and changes the light intensity correction amount on a basis of the calculated exposure ratio.

8. The image forming apparatus according to claim 4, wherein the exposure ratio is calculated in consideration of a gradation level.

9. An electrophotographic image forming apparatus that scans a surface of an image carrier with multiple beams emitted from a plurality of light emitting elements on a basis of image data, the apparatus comprising:
a bow corrector that performs electronic bow correction of image data;
a density smoothing processor that performs image slide on the image data subjected to the bow correction at a micro level and performs a density smoothing process;
a density correction processor that performs density correction on the image data subjected to the bow correction by light intensity correction in such a manner that a density level difference does not occur in a halftone image due to an influence of reciprocity failure in an inter-face exposure segment; and
one or more controllers that cause the density smoothing processor to perform processing with a grayscale cycle of a dither pattern as a cycle of a reference image slide.

10. The image forming apparatus according to claim 9, wherein image slide cycles larger than a reference of the cycle of the image slide include a cycle of an odd number.

11. The image forming apparatus according to claim 10, wherein the cycle of a minimum image slide is smaller than the cycle of the reference slide.
